(19) United States
(12) Patent Application Publication
(10) Pub. No.: US 2002/0002413 A1
(43) Pub. Date: Jan. 3, 2002

(54) Contents distribution system, portable terminal player, and contents provider

(76) Inventor: Jun Tokue, Gunma-ken (JP)

Correspondence Address: NATH & ASSOCIATES, 1030 15th STREET, 6TH FLOOR, WASHINGTON, DC, 20005, US

(21) Appl. No.: 09/891,393

(22) Filed: Jun. 27, 2001

(30) Foreign Application Priority Data
Jun. 30, 2000 (JP) P2000-197477
Jan. 26, 2001 (JP) P2001-17979

(51) Int. Cl. G06F 17/00

(52) U.S. Cl. 700/94; 381/61

(57) ABSTRACT

A contents distribution system comprises a contents provider and a user's portable terminal player. The contents provider, which comprises a contents server and a user information database storing therein user download information and right information, distributes contents over a communication network according to the SDMI check-in/check-out rule. The user's portable terminal player comprises a recording medium playback function that plays back the contents downloaded on a recoding medium and a check-in function that returns a playback right to the contents provider. When the contents are distributed to the portable terminal player, the contents provider manages contents distribution according to the check-in/check-out rule in such a way that the contents provider manages the number of check-outs of the contents to the user and, when the user checks in the distributed contents, the portable terminal player erases a contents playback encryption key and a file name and, at the same time, returns the playback right to the user information database.

### BACKGROUND OF THE INVENTION

1. Field of the Invention

The present invention relates to the technology of a system that distributes contents, such as music digital data, to a portable terminal player (a portable terminal such as a cellular phone or a PHS terminal combined with a recording medium and its player).

2. Description of the Related Art

A recent advancement in data compression technology, an improvement in transmission speed in communication networks (public switched telephone network, packet switched network, and so on), and an increase in the memory capacity of non-volatile semiconductors have put some new contents distribution systems into practical use. These new systems allow contents distribution subscribers (also referred to as users) to receive contents, such as music, by a personal computer (also referred to as a PC), a portable terminal (a cellular phone, PHS, and so on), or a kiosk terminal via the Internet or a PHS network and listen to the music by means of a audio device.

FIG. 1 shows a general configuration diagram of a contents distribution system. The contents distribution system comprises a contents provider 10 that includes a contents server 1 and a user information data base 5. The contents server 1 stores therein contents Cz obtained by conducting authoring in which actually recorded linear PCM contents data (raw contents) is watermarked to protect copyright and then the watermarked data is compressed with compression technologies such as MP3, ATRAC, or AAC while keeping the sound quality degradation to a minimum. The user information database 5 stores therein contents download information 3 on each subscriber and so on.

The contents Cz are encrypted and then transmitted to a user over a communication network 6. The user downloads the contents Cz to a hard disk (HDD) 14 of a personal computer 13 in a home 19. When the user wants to listen to them, he or she copies the contents Cz to a recording medium 11 (for example, a memory card, also called a media card, containing a non-volatile semiconductor memory such as a flash EPROM) and plays them back on a portable audio player 15 (hereinafter abbreviated PD (Portable Device)).

The following describes a procedure for distributing the contents from the contents provider 10 to the subscriber's PC 13. First, the subscriber on the PC 13 opens the web page HP on the Internet prepared by the contents provider 10 and selects a tune from the menu for purchase. The selected contents Cz are encrypted and then downloaded to the subscriber's PC 13 (a PC that is authorized to receive distributed music contents, generally called an LCM(Licensed Compliant Module)) over the communication network 6.

The user saves the downloaded contents Cz and the encryption key on the hard disk 14 of the PC 13. In general, the contents Cz are once decrypted and then encrypted with a different encryption method or a different encryption key for saving. The user can confirm the presence of the contents with the use of a file management application software program of the PC 13. However, the user does not know where the encryption key is stored on the PC.

The contents Cz saved on the hard disk 14 of the PC 13 as described above may be copied to the recording medium 11 via the USB (Universal Serial Bus) interface. However, the “Guide to the SDMI Portable Device Specification” prepared by the SDMI (Secure Digital Music Initiative; international project for drafting the standard format of the distribution and sales of music over a digital network) limits the number of copies from the hard disk 14 of the PC 13, which has received the distribution of the music contents Cz, to the recording medium 11 up to three times. Therefore, creating a fourth copy requires already copied contents Cz back to the PC 13. The contents management method provided as a copyright protection scheme for managing the number of copies as described above is called a check-in/check-out rule. The procedure for creating a copy from a PC 13 to an external medium is called check-out C_{OUT}, while returning a created copy back to the PC 13 is called check-in C_{IN}.

At check-out C_{OUT} time, actual contents Cz data is downloaded from the PC 13 to the recording medium 11. On the other hand, at check-in C_{IN} time, only a playback right M moves from the recording medium 11 to the PC 13, and the encryption key and the file name are erased from the recording medium 11. When new contents are recorded on the recording medium 11, the contents whose encryption key and file name have been erased are overwritten.

On the other hand, copyright protection processing (screening processing for writing a watermark in the contents data to check, at a later time, to see if the contents are copyrighted, valid contents) is performed in advance for the contents Cz distributed from the contents provider 10 and downloaded on the recording medium 11 of a portable terminal 21. The portable terminal 21, which is a cellular phone or a PHS terminal combined with a PD (hereinafter, this terminal is called a portable terminal player 20′), may directly play back the contents Cz. The above-described SDMI stipulates that contents Cz may be copied to the PC 13 only once. When the card becomes full, the contents Cz may be saved on the hard disk 14 of the PC 13 on condition that the contents Cz in the recording medium 11 will be erased. However, once the contents are moved to the PC 13, the number of copies is limited, and contents are managed, according to the check-in/check-out rule described above.

As described above, the SDMI's copyright protection scheme allows the contents Cz, distributed to the recording medium 11 of the portable terminal player 20′, to be moved to the PC (LCM) 13 only once on condition that copyright protection processing (screening processing) has already been done. This transfer of contents from the recording medium to the PC is called a “move”.

On the other hand, the SDMI's copyright protection scheme allows the contents, which are generated by compressing data on package media such as a music CD and recording the compressed data directly on the recording medium 11 by a ripping machine, to be moved to the PC (LCM) 13 only once on condition that the copyright protection processing (screening processing) has been done before writing the contents onto the recording medium 11. This transfer of contents from the recording medium to the PC is called a “migration”.

Incidentally, the ripping machine is a machine which reads out music data from a music CD. A personal computer may serve as a ripping machine. Here, the “ripping” includes compressing the music data by means of a compression algorithm such as MP3 as well as reading out the music data.

The SDMI assumes three categories for the relation among the PC 13 that receives distributed contents, the recording medium 11 to which contents are copied, and the PD 15 that plays back the contents, as shown in FIGS.2A-2C.

First, under category 1 shown in FIG. 2A, a PD 15a contains a non-volatile semiconductor memory chip 31 in which contents are recorded. The contents downloaded to the hard disk 14 of the PC 13 may be copied only to the PD 15a for playback.

Next, under category 2 shown in FIG. 2B, the ID number of a PD 15b connected to the PC 13 and the ID number (fixed) of a recording medium 11′ are read. With these ID numbers as a key, the contents are encrypted and recorded on the recording medium 11′. The contents, once recorded on the recording medium 11′, cannot be returned to the PC 13. Therefore, the contents may be copied from the PC 13 to an external medium up to three times, and the contents recorded on the recording medium 11′ can be played back, not even on another PD of the same type, but only on the PD 15b to which the contents were copied, because the PD must have a matching ID number. The user finds it difficult to use category 2 because category 2, though very secure, lacks flexibility in the use of the recording medium 11′.

Next, under category 3 shown in FIG. 2C, the recording medium 11 contains a microcomputer (CPU) and a non-volatile semiconductor memory. The PC 13, the recording medium 11, and a PD 15c check security each other to ensure playback compatibility. The encryption key may be read and written. Therefore, any secure PD allows the user to play back the encrypted contents which a card R/W 12 has recorded on the recording medium 11. Category 3,most convenient to the user, will become a mainstream contents distribution system in future.

Under category 3 described above, the contents once downloaded from the contents provider 10 to the PC 13 are managed by the user according to the SDMI check-in/check-out rule, one of copyright protection schemes. The problems with this category will be described below.

When the hard disk 14 of the PC 13 has become full or when the user has bought a new PC 13, the user must either move the contents to a new hard disk or visit a PC maker service center to do so. In addition, when the hard disk 14 is damaged, the contents distributor must download the contents again based on the user's purchase log information. Considering the communication cost that is very high, the user will probably give up obtaining all the contents at a time. That is, the user finds the hard disk 14 difficult to use and less reliable for saving contents although it is very large in capacity.

In addition, because the recording medium 11 containing a CPU is very expensive (the memory card is about $200), the user cannot have many recording media 11 as he or she does with minidisks (about $2). Therefore, the user may have an amount of contents that may be recorded on at most one or two recording media 11 (one or two hours of contents) for playing them back away from home. To record a new tune on the recording medium 11, the user must return home to copy it from the hard disk 14 of the PC 13. This is cumbersome.

The portable terminal player 20′ requires the user to purchase and download a new tune from the contents provider 10. However, the user does not purchase a tune if it is already purchased and downloaded to the hard disk 14, meaning that the user feels it inconvenient to play back an already-downloaded tune while away from home.

The user can record tunes on the recording medium 11 by ripping them from package media, such as a user's own CD, and play them back by the portable terminal player 20′ away from home. However, because the recording medium 11 containing a CPU is expensive as described above, the user cannot record many tunes (contents) on the recording medium 11.

As far as this is concerned, the conventional contents distribution system, such as the one shown in FIG. 1, is designed only to distribute the contents Cz stored in the contents server 1 of the contents provider 10, but not designed to take into consideration the storage of the contents at user side and the later distribution of the contents to the portable terminal player 20′.

Considering a rapid increase in the number of portable terminals currently owned by most people including students, it is expected that the portable terminal player 20′ will become rapidly popular and that newly released popular tunes will be distributed to the portable terminal player 20′ most often. However, even music contents for which authoring has been done requires a long download time. Therefore, it is expected that the user will find it difficult, via the portable terminal player 20′, to connect to the contents provider 10 that both sells and distributes contents.

### SUMMARY OF THE INVENTION

In view of the foregoing, it is an object of the present invention to provide a contents distribution system, designed for use by portable terminal players, that allows a distributor to build a copyright protection scheme essential to the distributor, that makes subscribers feel easy to use, and that lowers the communication cost and the management cost.

To solve the above problems, there is provided a contents distribution system comprising: a contents provider that comprises a contents server and a user information database and that distributes contents to a subscriber over a communication network, the contents server storing therein authored contents, the user information database having an area in which subscriber's contents download information and right information are recorded; and a portable terminal player, owned by the subscriber, that comprises a recording medium playback function playing back the contents downloaded to a recording medium and a playback right return function returning a playback right back to the contents provider, the playback right allowing the subscriber to play back the downloaded contents, wherein the contents provider manages contents distribution to the subscriber in such a way that, when the contents are distributed to the portable terminal player of the subscriber, the contents provider manages a number of downloads of the contents to the subscriber and, when the subscriber returns the playback right of the distributed contents back to the contents provider, the portable terminal player erases a key for playing back the contents and a file name recorded on the recording medium and, at the same time, returns the playback right to the area in which the right information is recorded in the user information database.

To solve the above problems, there is provided a contents distribution system comprising: a contents provider that comprises a contents server and a user information database and that distributes contents to a subscriber over a communication network according to an SDMI (Secure Digital Music Initiative) check-in/check-out rule, the contents server storing therein authored contents, the user information database having an area in which subscriber's contents download information and right information are recorded; and a portable terminal player, owned by the subscriber, that comprises a recording medium playback function playing back the contents downloaded to a recording medium and a check-in function returning a playback right back to the contents provider, the playback right allowing the subscriber to play back the downloaded contents, wherein the contents provider manages contents distribution to the subscriber according to the SDMI check-in/check-out rule in such a way that, when the contents are distributed to the portable terminal player of the subscriber, the contents provider manages a number of check-outs of the contents to the subscriber and, when the subscriber checks in the distributed contents, the portable terminal player erases a key for playing back the contents and a file name and, at the same time, returns the playback right to the area in which the right information is recorded in the user information database.

To solve the above problems, there is provided a contents distribution system comprising: a contents provider that comprises a contents server and a user information database and that distributes contents to a subscriber over a communication network and saves and distributes user-migrated contents into and from the contents server, the user information database having an area in which subscriber's contents download information and right information are recorded; and a portable terminal player, owned by the subscriber, that comprises a recording medium playback function playing back the contents downloaded to a recording medium and a check-in function returning a playback right back to the contents provider, the playback right allowing the subscriber to playback the downloaded contents, wherein, when the subscriber migrates ripped contents to the contents server of the contents provider from the portable terminal player according to an SDMI rule, the contents provider manages a distribution of the migrated contents to the subscriber according to the SDMI check-in/check-out rule.

To solve the above problems, there is provided a contents distribution system comprising: a contents provider that comprises a contents server storing therein authored contents and that supplies the contents to a contents distributor; the contents distributor that comprises a distribution contents server in which the contents supplied from the contents provider are stored and a user information database having an area in which subscriber's contents download information and right information are recorded and that distributes the contents to a subscriber; and a portable terminal player, owned by the subscriber, that comprises a recording medium playback function playing back the contents distributed from the contents distributor and downloaded to a recording medium and a check-in function returning a playback right back to the contents distributor, the playback right allowing the subscriber to play back the downloaded contents, wherein the contents distributor manages contents distribution from the distribution contents server to the portable terminal player according to an SDMI check-in/check-out rule in such a way that, when the contents are distributed to the portable terminal player of the subscriber, the contents distributor manages a number of check-outs of the contents to the subscriber and, when the subscriber checks in the distributed contents to the contents distributor, the portable terminal player erases a key for playing back the contents and a file name and, at the same time, returns the playback right to the area in which the right information is recorded in the user information database.

In a preferred embodiment of the present invention, the contents distributor further comprises a user contents server in which contents ripped by the subscriber are stored and, when the subscriber directly transmits the contents to the user contents server while ripping and compressing the contents or migrates the contents that have been recorded in the recording medium according to the SDMI rule, the contents distributor manages contents distribution from the user contents server to the subscriber's portable terminal player according to the SDMI check-in/check-out rule.

To solve the above problems, there is provided a contents distribution system comprising: a contents provider that comprises a contents server storing therein authored contents and that supplies the contents to a contents distributor; the contents distributor that comprises a distribution contents server in which the contents supplied from the contents provider are stored and a user information database having an area in which subscriber's contents download information is stored; a general server that comprises a user contents server in which the contents transmitted from the contents distributor or the contents ripped or moved by a subscriber are stored and a user information database having an area in which subscriber's right information is recorded and that distributes the contents from the user contents server to a subscriber's portable terminal player; and the portable terminal player, owned by the subscriber, that comprises a recording medium playback function playing back the contents downloaded from the contents distributor or the general server to a recording medium and a check-in function returning a playback right back to the general server, the playback right allowing the subscriber to play back the downloaded contents, wherein, when the contents purchased by the subscriber and downloaded to the recording medium are moved to the user contents server of the general user according to an SDMI rule or when the subscriber directly transmits the contents to the user contents server while ripping and compressing the contents or migrates the contents that have been recorded in the recording medium according to the SDMI rule, the general server manages contents distribution from the user contents server to the subscriber's portable terminal player according to the SDMI check-in/check-out rule.

To solve the above problems, there is provided a portable terminal player that comprises a download function downloading contents to a recording medium, the contents being distributed via a communication network, a recording medium playback function playing back the contents downloaded to the recording medium, and a playback right return function returning a playback right back to a distributor, the playback right allowing the subscriber to play back the downloaded contents, wherein, when the playback right for playing back the contents recorded on the recording medium is returned, a key for playing back the contents and a file recorded on the recording medium are erased.

To solve the above problems, there is provided a contents provider that comprises a contents server storing therein authored contents and a user information database having an area in which subscriber's contents download information and right information are recorded, wherein, when the contents are distributed to a portable terminal player of the subscriber, the distribution is managed according to a number of times the contents are distributed and a registration of a playback right returned from the portable terminal player to the user information database or according to an SDMI check-in/check-out rule.

To solve the above problems, there is provided a contents provider that comprises a contents server and a user information database having an area in which subscriber's contents download information and right information are recorded, wherein a distribution of the contents to a portable terminal player of the subscriber and a saving of user's migrated contents to the contents server as well as a distribution of the user's migrated contents back to the portable terminal player are performed according to an SDMI check-in/check-out rule.

Simply speaking, the contents distribution system according to the present invention allows the contents provider to manage the distribution of user-purchased contents to the portable terminal player according to the SDMI check-in/check-out rule, one of copyright protection schemes, as if the contents provider was a PC in the home. In addition, the contents distribution system according to the present invention allows the user to save the contents of a user owned CD into the contents server in the contents provider through migration according to the SDMI rule. After that, the system manages the saved contents according to the check-in/check-out rule described above. In addition, the contents distribution system according to the present invention divides the distribution function between the contents provider and the contents distributor or among the contents provider, contents distributor, and general server to separate the operation into two, that is, contents distribution to subscribers and distribution management.

The nature, principle and utility of the invention will become more apparent from the following detailed description when read in conjunction with the accompanying drawings.

### BRIEF DESCRIPTION OF THE DRAWINGS

In the accompanying drawings:

FIG. 1 is a diagram showing the configuration of a conventional contents distribution system.

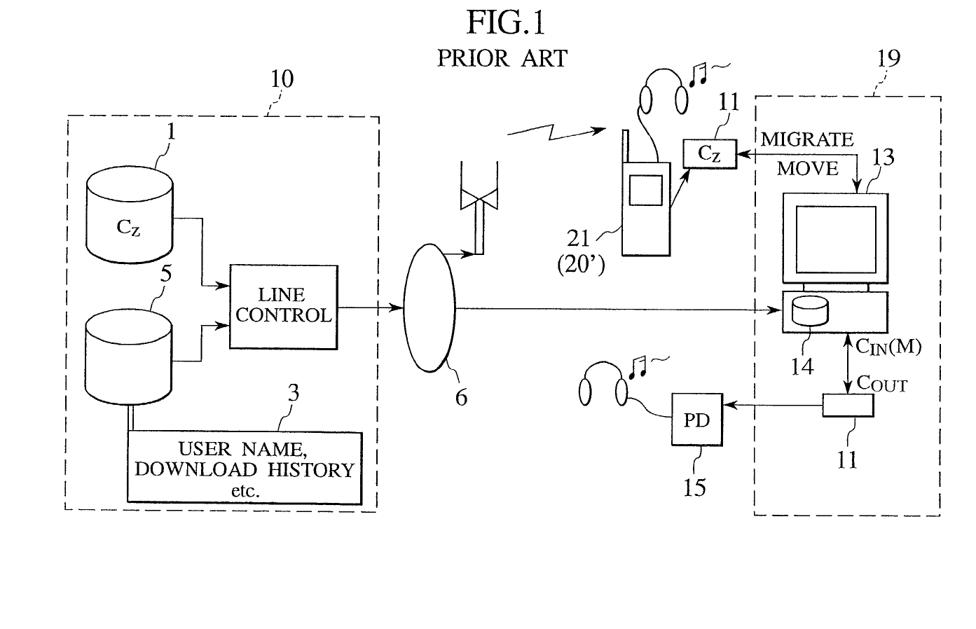

FIGS. 2A-2C are diagrams showing three categories the SDMI assumes for a PC (LCM) receiving contents distribution, a recording medium, and a PD.

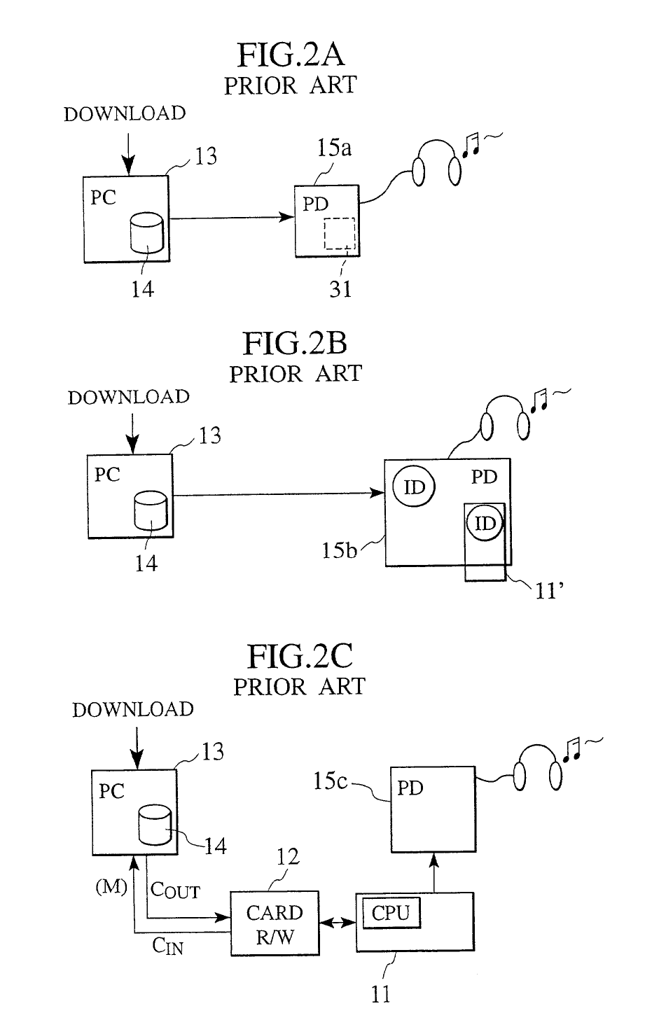

FIG. 3 is a diagram showing the configuration of a first contents distribution system according to the present invention.

FIG. 4 is a diagram showing the configuration of a second contents distribution system according to the present invention.

FIG. 5 is a diagram showing the configuration of a third contents distribution system according to the present invention.

FIG. 6 is a diagram showing the configuration of a fourth contents distribution system according to the present invention.

FIG. 7 is a block diagram showing a portable terminal player according to the present invention.

### DESCRIPTION OF THE PREFERRED EMBODIMENTS

Some embodiments of a contents distribution system according to the present invention will be described below with reference to the accompanying drawings. In the description below, a recording medium 11 is a medium that contains a CPU (the recording medium as described in category 3). It should be noted that, although the contents in the embodiments are copyrighted music contents, copyrighted video contents and text/drawing information contents are also included.

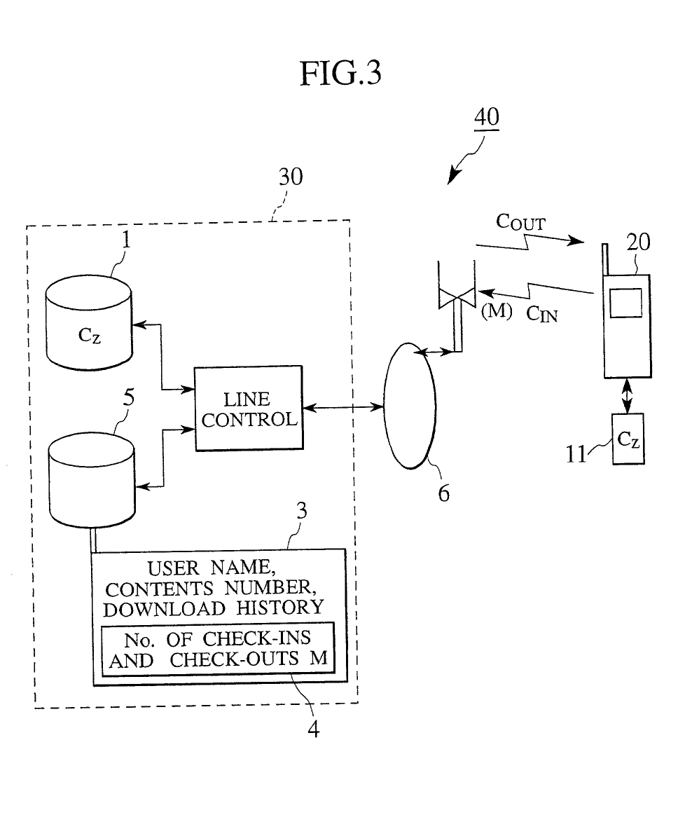

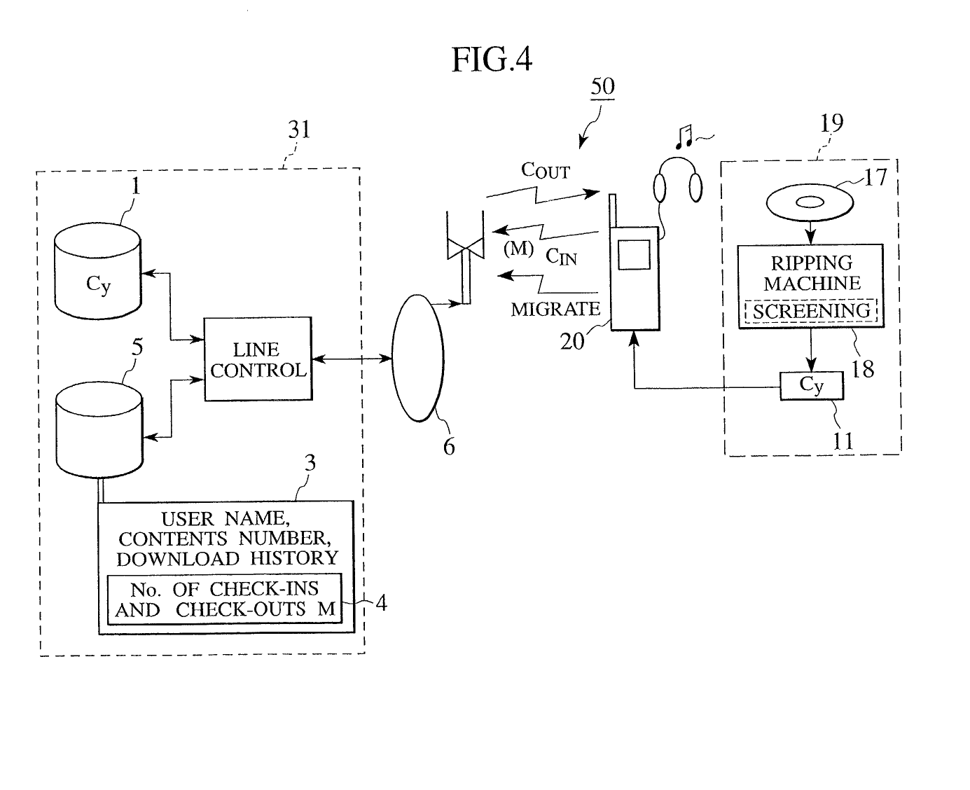

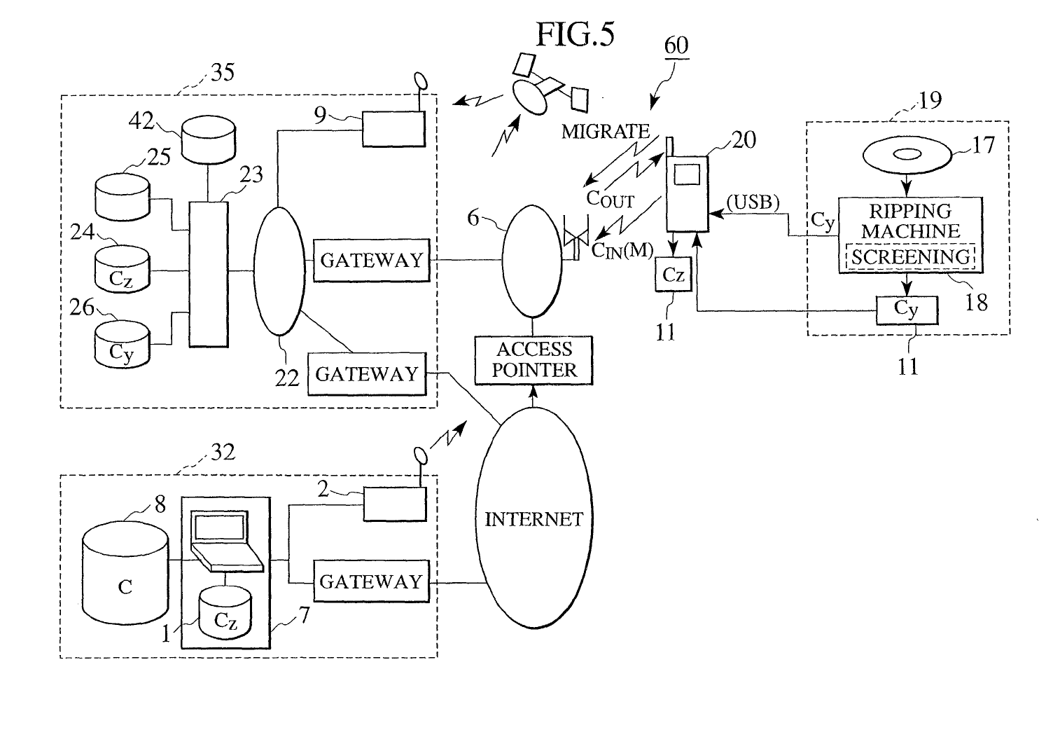

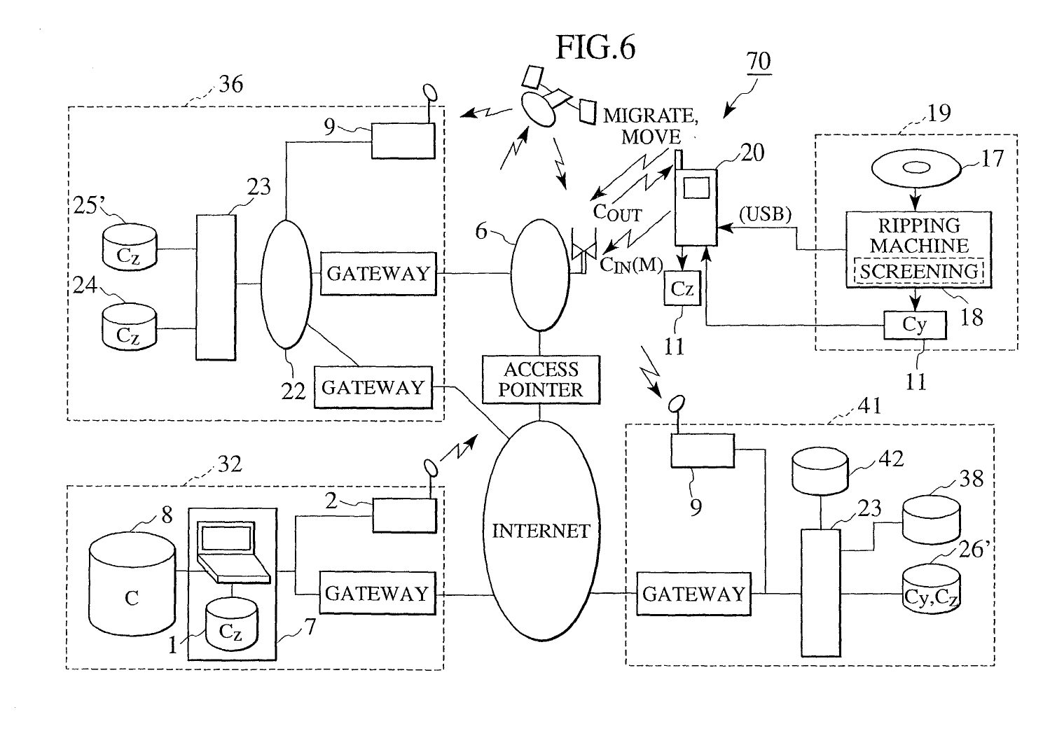

FIG. 3 is a diagram showing the configuration of a first contents distribution system 40 according to the present invention, and FIG. 4 is a diagram showing the configuration of a second contents distribution system 50 according to the present invention. FIG. 5 is a diagram showing the configuration of a third contents distribution system 60 according to the present invention, and FIG. 6 is a diagram showing the configuration of a fourth contents distribution system 70 according to the present invention.

Referring to FIG. 3, the contents distribution system 40 proposed by the present invention basically comprises a contents provider 30 and a portable terminal player 20. The contents provider 30 comprises a contents server 1 that contains contents Cz generated by authoring raw music contents and a user information database 5 that has areas in which contents download information 3 on each subscriber (user name, contents title, contents copyright holder, contents number, download history, contents operation rule, and soon) and right information 4 are recorded. The contents provider 30 distributes the contents Cz to subscribers over a communication network 6 (a general communication network including a cellular phone network and packet communication network). The portable terminal player 20, owned by a subscriber, comprises a recording medium playback function that plays back the contents Cz downloaded to the recording medium 11 and a playback right return function that returns the right M allowing the subscriber to play back the downloaded contents Cz back to contents provider 30. When the contents Cz are distributed to the portable terminal player 20 of the subscriber, the contents provider 30 manages the number of downloads of the contents Cz to the subscriber. When the subscriber returns the playback right M of the contents Cz distributed to the subscriber back to the contents provider 30, the portable terminal player 20 erases an encryption key for playing back the contents Cz and a file name recorded on the recording medium 11 of the portable terminal player 20 and, at the same time, returns the playback right M to the area in which the right information 4 is recorded in the user information database 5. In this way, the contents provider 30 manages the distribution of the contents Cz to the subscriber based on the number of downloads and the transfer of the playback right M.

It should be noted that this and following embodiments employ a common key cryptosystem in which an encryption key for encrypting contents is also used as a decryption key for decrypting the encrypted contents to be reproduced. Therefore, a decryption key is included in the meaning of an encryption key in this specification. In this sense, a key cryptosystem to which this invention is applied is not limited to a common key cryptosystem and thus this invention may be applied to a key cryptosystem in which an encryption key and a decryption key are different from each other.

For example, the subscriber purchases contents from the contents provider 30 using the portable terminal player 20 over the Internet, the allowable download count of the contents Cz is predefined as four. That is, the contents Cz downloaded at purchase time may be downloaded free of charge another three times. When the playback right M of the contents Cz the subscriber has purchased is returned to the contents provider 30, the allowable download count recorded in the recording area for the right information 4 in the user information database 5 is incremented by one, that is, the count is returned to the allowable download count before the download. The predefined allowable download count may be one. Managing contents distribution in this manner allows the user to return the playback right M of the once downloaded contents Cz to the contents provider to exchange various contents Cz on the recording medium 11. This eliminates the need for the user to purchase the same contents again but allows the user to download the contents as many times as he or she wants using only one recording medium, significantly increasing user convenience. In addition, because the playback right M is returned instantly without involving the contents Cz data movement, the communication charge is very small.

The SDMI check-in/check-out rule described in the prior art, if introduced as a copyright protection scheme of the contents distribution system 40 for the portable terminal player 20, makes a distribution system very reasonable for both the contents provider/distributor and the user.

That is, when the user in the contents distribution system 40, shown in FIG. 3, uses the portable terminal player 20 to electronically purchase (e-commerce) the contents Cz and downloads them from the distribution contents provider 30 over the communication network 6, the contents provider 30 records the user name, contents number, download history data and so on in the download information area 3 in the user information database 5 and records the number of check-ins/check-outs in the area where user's right information 4 is recorded. From this point on, the user may download the contents Cz purchased and downloaded to the recording medium 11 to another medium, free of charge and another three times, according to the SDMI rule. In this way, the system manages the distribution of contents according to the same copyright protection scheme as that of the SDMI check-in/check-out rule.

To return the contents Cz, once downloaded to the recording medium 11, to the contents provider 30, the portable terminal player 20 erases the playback encryption key of the contents Cz and returns the playback right M to the recording area of the right information 4 in the user information database 5 of the contents provider 30 (check-in C_{IN}).

Because check-out C_{OUT} is allowed up to four times, the contents once purchased may be downloaded up to four times consecutively. However, if the playback right M is returned (check-in C_{IN} is executed), the user may download (cₒᵤₜ) the contents again.

In the contents distribution system 40, too, when the user downloads the contents Cz to the recording medium 11 (C_{OUT}), the contents data moves from the distribution system to the recording medium but, when the contents Cz are returned (C_{IN}), only the playback right M for playing back the contents Cz is transmitted. Therefore, the amount of data that is transmitted is small, the transmission is completed instantly, and the communication charge is small.

The contents provider 30 creates an additional area in the conventional user information database 5 for recording the number of check-ins/check-outs of the contents Cz distributed to each user plus the playback right M.

In this way, introducing the copyright protection scheme, based on the SDMI check-in/check-out rule, into the contents distribution system for the portable terminal player 20 eliminates the need for the user to have his or her own PC. At the same time, this allows the user to restore the purchased contents Cz only for the communication charge if the user is in the cellular phone service area. Thus, the user with only one recording medium 11 may exchange contents away from home to play back more contents than are allowed by the capacity of the recording medium. The contents provider 30 may also manage the distribution of copyrighted contents reliably according to the SDMI rule.

Next, the SDMI stipulates a migration as described above. That is, the contents generated by ripping data from package media such as a user's music CD and then compressing it are stored, not on a hard disk, but directly on the recording medium 11 (memory card). The contents may be moved to the PC (LCM) only once on condition that copyright protection processing (watermark screening processing and so on) has been done before writing the contents on the recording medium 11.

Therefore, in a system such as the contents distribution system 50 shown in FIG. 4, the user may migrate contents Cy from the portable terminal player 20 to the contents server 1 (that functions as a user contents saving server) of a contents provider 31 over the communication network 6 according to the SDMI rule for saving the contents therein. These contents Cy are those generated by the user screening the contents and ripping them from package media 17 such as a CD with the use of a ripping machine 18. Once migrated, the contents Cy may be distributed from the contents provider 31 to the user according to the SDMI check-in/check-out rule. Then, the contents Cy generated by ripping from package media such as a user's music CD 17 maybe downloaded to the portable terminal player 20 under control of the check-in/check-out rule based on the copyright protection scheme even when the user is away from home. Of course, for the user owned contents Cy, the contents provider 31 also records the user name, contents number (ISRC and so on), download history, and so on into the download information area 3 in the user information database 5. At the same time, the contents provider 31 records the number of check-ins/check-outs and the playback right M in the area in which the right information 4 on each user is recorded.

The first migration and the subsequent check-out (download) from the contents provider 31 to the user's portable terminal player 20 require some time. However, this problem will be solved as the transmission speed of the cellular phone network and the PHS network increases (In IMT-2000, the transfer rate of 384K bps is assumed).

The contents distribution systems 40 and 50 described above are built assuming that the contents providers 30 and 31 have contents Cz generated by authoring raw contents and, at the same time, distribute the contents to user's portable terminal player 20. That is, it is assumed that contents providers (vendors) and distributors are the same group or one group. However, actually and strictly speaking, a contents provider (so called a record company) that owns copyrighted contents Cz and sells them to subscribers over the Internet and a contents distributor (a common carrier acting as a contents distributor) that has communication carriers for the distribution of contents Cz are separate corporations. Therefore, a contents distribution system comprising the three—contents provider, contents distributor, and subscriber—is more realistic.

In addition, although the contents distributor has a distribution server that distributes copyrighted contents supplied from the contents provider, there are much more general servers on the Internet. Therefore, a contents distribution system comprising the above three plus general servers is also possible.

On the other hand, when distributing music contents to the portable terminal player 20, it is essential to build a distribution system with particular emphasis on the copyright protection scheme and smooth distribution to subscribers. However, even in the higher-speed cellular phone network and the PHS network, it is expected that a subscriber cannot download music contents because the distribution of large-capacity music contents to the potable terminal player 20 exceeds the line capacity.

The communication infrastructure is being built rapidly, while already available high-speed communication lines such as ADSL (Asymmetric Digital Subscriber Line) lines, satellite communication lines, and high-speed communication network FTTH (Fiber To The Home) lines with the maximum speed of 10M bps are being put into practical use. These high-speed communication lines, when used to transmit contents among the contents provider, contents distributor, and general server, enables a large amount of contents to be transmitted very quickly, allowing contents to be distributed smoothly to the portable terminal player 20 of many subscribes.

Considering the above, the contents distribution system 60 shown in FIG. 5 comprises a contents provider 32, a contents distributor 35, and a portable terminal player 20. The contents provider 32, which has a contents server 1 in which the contents Cz generated by authoring raw contents 8 with the use of an authoring system 7 are stored, supplies the contents Cz via a satellite transmitter 2 to the contents distributor 35 via satellite communication (or via a high-speed data communication line such as FTTH). The contents distributor 35, which comprises a distribution contents server 24 that receives, with the use of a satellite receiver 9, the contents Cz supplied from the contents provider 32 via satellite communication and stores the contents therein and a user information database 25 that has the recording areas for contents download information and right information on each subscriber, distributes the contents Cz to subscribers via the communication network 6. The portable terminal player 20, which is owned by a subscriber, comprises a recording medium playback function that plays back the contents Cz distributed from the contents distributor 35 and downloaded to the recording medium 11 and a check-in function that returns the playback right M for playing back the downloaded contents Cz back to the contents distributor 35. When the subscriber electronically purchases the contents Cz using the portable terminal player 20, the contents distributor 35 manages the distribution of the contents Cz from the distribution contents server 24 to the portable terminal player 20 according to the SDMI check-in/check-out rule. In FIG. 5, numeral 22 indicates a network within the contents distributor 35, and numeral 23 indicates a proxy server that manages data communication among servers during data communication and protects server security. The gateway in the figure checks if an external terminal that issues a request to connect to the data communication network in the contents distributor 35 is allowed to connect. Of course, only subscribers may pass the gateway.

This system is different from the contents distribution system 40 in FIG. 3 in that the contents distributor 35 and the contents provider 32 are separate and that contents management based on the SDMI copyright protection scheme is done by the contents distributor 35.

The user purchases the contents in one of two ways. In one way, the user uses his or her own portable terminal player 20 to access the contents distributor 35 to download the contents from the distribution contents server 24. In the other way, the user connects to the web page of the contents provider 32 to purchase the contents Cz directly. In the latter way, the contents provider 32 transmits the contents Cz, over a high-speed transmission line (FTTH or satellite communication), to the distribution contents server 24 of the contents distributor 35 to which the user subscribes and, at the same time, transmits subscriber's additional information to the user information database 25 to register the subscriber with the database. After the transmission, the contents distributor 35 transmits a message to the user's portable terminal player 20 to tell that the contents Cz have been transmitted from the contents provider 32 to the contents distributor 35. Then, the user can send contents to, or receive contents from, the distribution contents server 24 according to the check-in/check-out rule.

Next, the configuration in which the contents distributor 35 in the contents distribution system 60 shown in FIG. 5 has a user contents server 26 in which user's own contents Cy, created by ripping from package media, are stored will be described. The user transmits his or her own contents to the user contents server 26 in one of two ways. In one way, the user connects the portable terminal player 20 to the user contents server 26 via the USB to directly transmit the contents while ripping and compressing them with a ripping machine 18. In the other way, the user records the contents on the recording medium 11 and then migrates them according to the SDMI rule. After that, the contents distributor 35 manages the contents Cy distributed from the user contents server 26 to the subscriber's portable terminal player 20 according to the SDMI check-in/check-out rule. This configuration gives the user the same advantage as that of the contents distribution system 50 shown in FIG. 4.

Next, the contents distribution system 70 shown in FIG. 6 comprises a contents provider 32, a contents distributor 36, a general server 41, and a portable terminal player 20. The contents provider 32, which comprises a contents server in which the contents Cz generated by authoring raw contents 8 with the authoring system 7 in the same manner as in FIG. 5 are stored, supplies the contents to the contents distributor 36 from the satellite transmitter 2 via satellite communication. The contents distributor 36 at least comprises a distribution contents server 24 in which the contents supplied from the contents provider 32 and received by the satellite receiver 9 are stored and a user information database 25′ which has an area for recording download information on the subscribers. The general server 41, which comprises a user contents server 26′ in which the contents Cz transmitted from the contents distributor 36 via a high-speed communication network, user's own contents Cy created by the subscriber ripping with the ripping machine 18, or the contents Cz moved by the subscriber are stored and a user information database 38 which has an area for recording the right information on the contents Cz and Cy of each subscriber, distributes the contents Cz and Cy from the user contents server 26′ to the subscriber's portable terminal player 20. The portable terminal player 20, which is owned by a subscriber, comprises a recording medium playback function that plays back the contents Cz and Cy downloaded from the contents distributor 36 or the general server 41 to the recording medium 11 and a check-in function that returns the playback right M for playing back the downloaded contents Cz back to the general server 41.

In the system 70, the subscriber electronically purchases the contents Cz from the contents provider 32 or the contents distributor 36, downloads them to the recording medium 11, and moves them to the user contents server 26′ of the general server 41 according to the SDMI rule. Alternatively, the subscriber rips and compresses the contents of subscriber's own package media, such as a CD 17, and directly transmits obtained contents Cy by the portable terminal player 20 via the USB or records the obtained contents Cy on the recording medium 11 and then migrates them according to the SDMI rule. After that, the general server 41 manages the contents Cy and Cz to be distributed from the user contents server 26′ to the subscriber's portable terminal player 20 according to the SDMI check-in/check-out rule. In the system contents described above, the user must make an online contract, in advance, with the general server 41 for the capacity required for saving the contents using the Internet connection function of the portable terminal player 20.

Thus, with purchased contents Cz or owned contents Cy saved in the user contents server 26′ of the general server 41, the subscriber checks in or out them with the portable terminal player 20 away from home. This ability enables the subscriber to freely exchange the contents on the recording medium 11 while enabling the copyright protection scheme.

In addition, purchasing large-volume contents, such as an album including scores of tunes, and downloading the contents directly to the portable terminal player 20 via a cellular phone line takes long because the transmission speed is low. In this case, transmitting the contents to the user contents server 26′ of the general server 41 over a high-speed communication network, such as the FTTH or satellite communication, reduces the transmission time and therefore lowers the communication cost. Figuratively speaking, the subscriber purchases the contents Cz and transfers them to the subscriber's account (data area) in the user contents server 26′ of the general server 41 that acts as a bank. After the purchase, the subscriber only have to check-out the purchased contents Cz from the user contents server 26′. This avoids the problem that the cellular phone line is busy.

In the contents distribution systems 60 and 70 described above, a copyrighted contents management information database 42 (in which CD management number code and the corresponding additional information such as the contents tile, author's name, and performer's name are saved) may be created in the server (contents distributor 35 or general server 41) that distributes contents to subscribers. In this case, when the subscriber directly transmits or migrates the ripped contents Cy to the user contents server 26 (26′), unique information containing a contents management number (for example, a bar code attached to the CD, tune number, ISRC, etc.,) is first transmitted to the user contents server 26 (26′). The server checks the unique information on the transmitted contents and, if the same contents Cy are already stored in the user contents server 26 (26′), the server does not receive the contents Cy but registers a subscriber's contents Cy sharing right (a check-in/check-out right) with the user information database 25 (25′). This eliminates the need for transmitting all contents data and reduces the communication time.

That is, the contents of a user's CD have an embedded watermark, several bits in length, where copy management information is written. Another piece of information may also be written in the same way. If an attempt is made to store the contents already stored in the user contents server 26 (26′) into the user contents server 26 (26′) again, this information is used to write the sharing right information on the contents into the user information database 25 (25′). As a result, the user can check in or check out the contents without having to actually transmit the contents. This also allows the server to save on the capacity and lowers the server charge to the user.

For example, assume that the user knows that unique information such as ISRC is embedded in the contents the user owns. In this case, the user accesses the server, types the contents management number, and checks if the contents Cy the user is going to save are already stored in the user contents server 26 (26′). If the contents are already stored, the user reproduces a part (about 15 seconds) of the contents Cy and transmits only the unique information to the server. Upon receiving the information, the server checks the contents management information database 42 for the received contents management number and the unique information embedded in the contents. The contents management information database 42 contains information on the correspondence between contents management numbers and unique codes. If the relation is found to be valid as a result of the checking, a check is made to see if the contents with the same number as the contents management number sent from the server are saved in the user contents server 26 (26′). If the same contents are found, only the sharing right information for the contents Cy is registered with the user information database 25 (25′). As a result, the user need not transmit all contents Cy data.

This saves the user the communication charge required for migration transmission. The server may also share the contents data to save on the data capacity.

If contents sharing is allowed without checking the contents management number and unique information, it is impossible to identify whether the user actually owns the contents Cy. Even if the user does not have the CD, simply entering the contents management number attached on the CD package allows the contents in the server to be shared. To prevent this, this system always reproduces the contents about 15 seconds at migration time and transmits the contents management number as well as the embedded unique information to the server to enable the server to check the contents management number and the unique information.

Finally, it is assumed that, when the user purchases the portable terminal player 20 in the contents distribution systems 40, 50, 60, and 70 described above, the user subscribes to the contents distribution service or, with the Internet connection function of the cellular phone, makes an online contract of the service. Only the portable terminal player 20 that has made this contract may pass the gateway to receive the distribution service and the contents saving service.

The following describes an example of a procedure (1) for purchasing the contents Cz with the portable terminal player 20 and for checking in and out the contents in the contents distribution system 60 described above.

(1-1) Select contents; The user makes a call from the portable terminal player 20 to connect to the network 22 in the contents distributor 35 to transmit a connection request message to the address pre-registered in the terminal 20. At this time, the request message is transmitted to the gateway of the contents distributor 35 over the communication network 6 (radio public network) of the communication carrier. If the gateway confirms that the message is valid, the contents distributor accepts the request and returns the selection menu to the terminal 20. When the selection menu is too large to send at a time, the terminal 20 issues a request, one selection menu step at a time, to the contents distributor 35 to ask it to send the menu repeatedly. Upon receiving an audition request from the terminal 20, the contents distributor stream-transmits the audition contents to allow the user to play them back in real time. If the user finds the contents Cz satisfactory, he or she selects them from the menu. Then, a contents purchase transmission request for the selected contents Cz is transmitted from the terminal 20 to the contents distributor 35.

(1-2) Transmit the contents; In response to the contents purchase transmission request from the terminal 20, the contents distributor 35 transmits the contents Cz. Before being transmitted, the contents Cz are encrypted. The encryption key is encrypted and then transmitted to the terminal after an SSL (Secure Socket Layer) session is established between the server and the terminal 20. The contents encrypted separately are also transmitted. The contents encryption key and the encrypted contents may be transmitted in any order. After transmission, additional information, such as the name, contents title, number of check-outs (2 immediately after download), and download date and time, is written in the user information database 25 included in the contents distributor 35.

(1-3) Check-in the contents; The contents Cz downloaded to the portable terminal player 20 may be checked-in to the server of the contents distributor 35. When the contents are checked-in, the number of check-outs in the user area in the user information database 25 is incremented. This does not involve the movement of the contents from the terminal 20 to the server. The file of the contents that have been checked-in is erased from the recording medium 11.

(1-4) Check-out the contents; When the purchased contents Cz are checked-out from the server, the contents Cz moves from the server to the terminal 20 and the check-out counter in the user information database 25 is decremented.

Thereafter, the contents Cz check-in and check-out are repeated as described in (1-3) and (1-4).

Next, the following describes a procedure (2) for storing the user's CD contents into the user contents server 26 of the contents distributor 35 in the contents distribution system 60 described above.

(2-1) Transmit the contents; The contents of a user's played-back CD are watermarked by a ripping machine 18, compressed, and encrypted (After processing, the contents become contents Cy). Then, the contents are transmitted in one of two ways: (a) The ripping machine 18 is connected to the terminal 20, from which the contents are transmitted directly to the user contents server 26. (b) The contents Cy compressed in the ripping machine 18 are once recorded on the recording medium 11 and then migrated through the terminal 20 to the user contents server 26. In either case, the key used to encrypt the contents is encrypted in an SSL session described above and is transmitted separately from the contents.

First, in the case of (a) in which the contents Cy are transmitted, not via the recording medium 11, but directly to the server 26, the user enters the CD management number attached on the CD package and a tune number included in the CD from the key entry unit of the terminal 20 before transmitting the contents Cy. A number attached on a CD package, which is managed by a record company, is unique among all CDs. Record stores usually manage CDs using this number. Therefore, this management number and a tune number uniquely identify a specific tune in a specific CD. The correspondence between actual numbers and CD titles is stored in the contents management information database 42 in the contents distributor 35. With this data, additional information, such as the title, performer, copyright holder, and record company of the transmitted contents Cy, is automatically stored in the customer database.

Next, in the case of (b) in which the contents are migrated via the recording medium 11, the contents are recorded on the recording medium 11, which is inserted into the portable terminal 20. Then, the user uses the key entry function of the terminal 20 to write additional information, such as the title, into the card. This information is made to correspond to the contents Cy and is saved on the card. At transmission time, additional information as well as the contents is transmitted to the distributor 35. At this time, when the CD management number attached on the CD package is entered and this information in conjunction with the contents Cy is transmitted as in the case of (a), additional information other than those entered by the user is added and stored in the user information database 25.

(2-2) Save the contents; The transmitted contents Cy are saved in the user contents server 26. From this time on, the check-out and check-in of the contents is managed as with the distributed contents Cz.

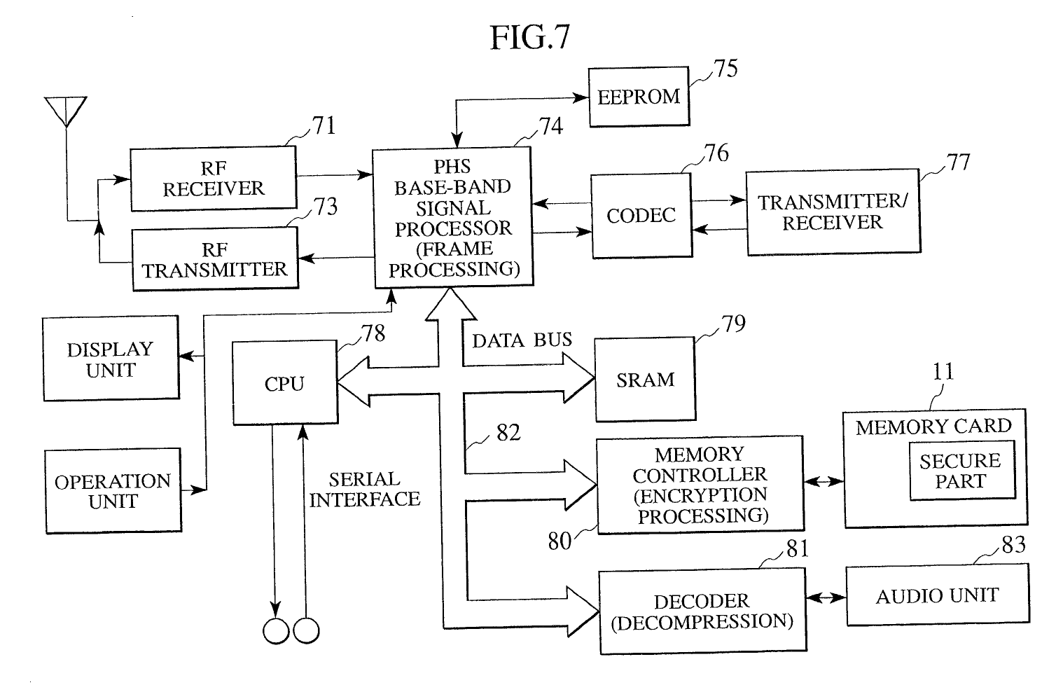

The portable terminal player 20 used in the distribution system according to the present invention, with the configuration of the PHS terminal shown in the block diagram in FIG. 7, is equivalent in structure to a known portable terminal player. That is, the player comprises the download function for downloading the contents distributed over the communication network to the memory card used as the recording medium 11 and the recording medium playback function for playing back the contents Cz downloaded to the recording medium 11. The player further comprises the playback-right return function for returning the playback right M with which the downloaded contents Cz are to be played back. When the playback right M for playing back the distributed contents Cz is returned to the distributor (contents providers 30 and 31, contents distributor 35, or general server 41), the CPU controls a memory controller 80 of the recording medium 11 such that the encryption key for playing back the contents Cz recorded on the recording medium 11 (memory card) and the file name are erased. This playback-right return function makes it possible for distributor to manage the distribution according to the SDMI check-in/check-out rule.

The operation of the portable terminal player 20 will be outlined below with the PHS terminal in FIG. 7 as an example. An RF receiver 71 amplifies a high-frequency signal (1.9 GHz band) received by an antenna 72 and converts it to a low-frequency signal (10.8 MHz band). An RF transmitter 73 modulates the digital signal, which is to be transmitted, in the QPSK (quadraphase shift keying) method with the phase shift of π/4 to produce a high-frequency signal (1.9 GHz band). A base-band signal processor 74 causes its controller to control calls, radio signals, and move management with the master phone or the base station and, at the same time, controls the LCD display and extracts the operation signal. The base-band signal processor 74 also causes its receiver to demodulate the received signal, to de-scramble the signal, to detect errors in transmission data, and to extract data from a packet string at data reception time. The base-band signal processor 74 also causes its transmitter to generate the modulated signal from the transmission digital signal, to scramble the transmission signal, to add the error detection signal to the transmission data, and to create transmission data packets. An EEPROM 75 stores therein the ID number and telephone number of the portable terminal player 20, user-entered personal identification number, or contents account information. A CODEC 76 encodes and decodes the voice signal during voice communication in the ADPCM method. A transmitter/receiver 77 converts the voice to analog electric signal with the receiver, amplifies the converted signal, and send it to the CODEC 76 and, at the same time, amplifies the analog data signal output from the CODEC 76 and transmits it to the microphone. A CPU 78 controls a data bus 82 between the base-band signal processor 74 and an SRAM 79, a memory controller 80, and an (AAC) decoder 81. The CPU also has a serial data interface to allow data to be transferred between an external unit and the internal data bus 82. The SRAM 79 is a buffer for adjusting the data processing speed in the ICs connected via the data bus 82. A memory controller 80, a controller controlling the read and write operations of data transferred between the portable terminal player 20 and the removable recording medium 11, encrypts/decrypts data and protects copyright. The recording medium 11 (memory card) comprises an internal controller and memory devices such as flash EPROMs. The internal controller reads data from, or writes data to, the memory controller 80 and manages copyright protection data. The memory devices are divided into the secure part and general data part. The secure part may be rewritten only when a specific authentication requirement between the part and the internal controller is satisfied. The (AAC) decoder 81 decompresses the compressed contents (mostly, digital music signal) and converts them to the analog audio signal. An audio unit 83 amplifies the analog signal output from the decoder 81 and sends the played-back sound through a headphone.

The contents distribution system, portable terminal player, and contents provider according to the present invention have the following advantages:

(1) Contents are downloaded from the contents provider to the user's portable terminal player according to the SDMI check-in/check-out rule. Therefore, the user is able to download to replace the contents of a recording medium freely away from home. This means that the user can have contents more than the capacity of the recording medium.

(2) Because only the playback right information is transmitted at check-in time, the communication charge is very small.

(3) The contents such as user's package media may be migrated to the contents server of the contents provider. This function allows the user to download the contents to the portable terminal player away from home.

(4) Contents management according to the SDMI rule makes the distribution system a high-security system with copyright protection in mind.

(5) Separation of the distributor into a contents provider and a contents distributor makes contents sales and distribution management more efficient.

(6) General servers, when added to the system, make distribution work for users split and smoothed.

It should be understood that many modifications and adaptations of the invention will become apparent to those skilled in the art and it is intended to encompass such obvious modifications and changes in the scope of the claims appended hereto.

What is claimed is:

1. A contents distribution system comprising:
a contents provider that comprises a contents server and a user information database and that distributes contents to a subscriber over a communication network, said contents server storing therein authored contents, said user information database having an area in which subscriber's contents download information and right information are recorded; and
a portable terminal player, owned by the subscriber, that comprises a recording medium playback function playing back the contents downloaded to a recording medium and a playback right return function returning a playback right back to said contents provider, said playback right allowing the subscriber to play back the downloaded contents,
wherein said contents provider manages contents distribution to the subscriber in such a way that, when the contents are distributed to said portable terminal player of the subscriber, said contents provider manages a number of downloads of the contents to the subscriber and, when the subscriber returns the playback right of the distributed contents back to said contents provider, said portable terminal player erases a key for playing back the contents and a file name recorded on the recording medium and, at the same time, returns the playback right to the area in which the right information is recorded in said user information database.

2. A contents distribution system comprising:
a contents provider that comprises a contents server and a user information database and that distributes contents to a subscriber over a communication network according to an SDMI (Secure Digital Music Initiative) check-in/check-out rule, said contents server storing therein authored contents, said user information database having an area in which subscriber's contents download information and right information are recorded; and
a portable terminal player, owned by the subscriber, that comprises a recording medium playback function playing back the contents downloaded to a recording medium and a check-in function returning a playback right back to said contents provider, said playback right allowing the subscriber to play back the downloaded contents,
wherein said contents provider manages contents distribution to the subscriber according to the SDMI check-in/check-out rule in such away that, when the contents are distributed to said portable terminal player of the subscriber, said contents provider manages a number of check-outs of the contents to the subscriber and, when the subscriber checks in the distributed contents, said portable terminal player erases a key for playing back the contents and a file name and, at the same time, returns the playback right to the area in which the right information is recorded in said user information database.

3. A contents distribution system comprising:
a contents provider that comprises a contents server and a user information database and that distributes contents to a subscriber over a communication network and saves and distributes user-migrated contents into and from the contents server, said user information database having an area in which subscriber's contents download information and right information are recorded; and
a portable terminal player, owned by the subscriber, that comprises a recording medium playback function playing back the contents downloaded to a recording medium and a check-in function returning a playback right back to said contents provider, said playback right allowing the subscriber to play back the downloaded contents,
wherein, when the subscriber migrates ripped contents to the contents server of said contents provider from said portable terminal player according to an SDMI rule, said contents provider manages a distribution of the migrated contents to the subscriber according to the SDMI check-in/check-out rule.

4. A contents distribution system comprising:
a contents provider that comprises a contents server storing therein authored contents and that supplies the contents to a contents distributor;
the contents distributor that comprises a distribution contents server in which the contents supplied from said contents provider are stored and a user information database having an area in which subscriber's contents download information and right information are recorded and that distributes the contents to a subscriber; and
a portable terminal player, owned by the subscriber, that comprises a recording medium playback function playing back the contents distributed from said contents distributor and downloaded to a recording medium and a check-in function returning a playback right back to said contents distributor, said playback right allowing the subscriber to play back the downloaded contents,
wherein said contents distributor manages contents distribution from said distribution contents server to said portable terminal player according to an SDMI check-in/check-out rule in such a way that, when the contents are distributed to said portable terminal player of the subscriber, said contents distributor manages a number of check-outs of the contents to the subscriber and, when the subscriber checks in the distributed contents to said contents distributor, said portable terminal player erases a key for playing back the contents and a file name and, at the same time, returns the playback right to the area in which the right information is recorded in said user information database.

5. The contents distribution system according to claim 4, wherein the contents distributor further comprises a user contents server in which contents ripped by the subscriber are stored and, when the subscriber directly transmits the contents to said user contents server while ripping and compressing the contents or migrates the contents that have been recorded in the recording medium according to the SDMI rule, said contents distributor manages contents distribution from said user contents server to the subscriber's portable terminal player according to the SDMI check-in/check-out rule.

6. A contents distribution system comprising:
a contents provider that comprises a contents server storing therein authored contents and that supplies the contents to a contents distributor;
the contents distributor that comprises a distribution contents server in which the contents supplied from said contents provider are stored and a user information database having an area in which subscriber's contents download information is stored;
a general server that comprises a user contents server in which the contents transmitted from said contents distributor or the contents ripped or moved by a subscriber are stored and a user information database having an area in which subscriber's right information is recorded and that distributes the contents from said user contents server to a subscriber's portable terminal player; and
the portable terminal player, owned by the subscriber, that comprises a recording medium playback function playing back the contents downloaded from said contents distributor or said general server to a recording medium and a check-in function returning a playback right back to said general server, said playback right allowing the subscriber to play back the downloaded contents,
wherein, when the contents purchased by the subscriber and downloaded to the recording medium are moved to the user contents server of the general user according to an SDMI rule or when the subscriber directly transmits the contents to the user contents server while ripping and compressing the contents or migrates the contents that have been recorded in the recording medium according to the SDMI rule, said general server manages contents distribution from said user contents server to the subscriber's portable terminal player according to the SDMI check-in/check-out rule.

7. A portable terminal player that comprises a download function downloading contents to a recording medium, said contents being distributed via a communication network, a recording medium playback function playing back the contents downloaded to the recording medium, and a playback right return function returning a playback right back to a distributor, said playback right allowing the subscriber to play back the downloaded contents, wherein, when the playback right for playing back the contents recorded on the recording medium is returned, a key for playing back the contents and a file recorded oh the recording medium are erased.

8. A contents provider that comprises a contents server storing therein authored contents and a user information database having an area in which subscriber's contents download information and right information are recorded, wherein, when the contents are distributed to a portable terminal player of the subscriber, the distribution is managed according to a number of times the contents are distributed and a registration of a playback right returned from said portable terminal player to said user information database, or according to an SDMI check-in/check-out rule.

9. A contents provider that comprises a contents server and a user information database having an area in which subscriber's contents download information and right information are recorded, wherein a distribution of the contents to a portable terminal player of the subscriber and a saving of user's migrated contents to said contents server as well as a distribution of the user's migrated contents back to said portable terminal player are performed according to an SDMI check-in/check-out rule.
